(19) United States
(12) Patent Application Publication
(10) Pub. No.: US 2010/0188020 A1
(43) Pub. Date: Jul. 29, 2010

(54) HIGH FREQUENCY BALLAST FOR A FIXED OUTPUT HIGH INTENSITY DISCHARGE LAMP

(75) Inventor: Cheng-Hsien Chen, Taipei (TW)

Correspondence Address: Muncy, Geissler, Olds & Lowe, PLLC, 4000 Legato Road, Suite 310, FAIRFAX, VA, 22033, US

(73) Assignee: Yeou Wang Enterprise Co., Ltd.

(21) Appl. No.: 12/359,856

(22) Filed: Jan. 26, 2009

(51) Int. Cl. H05B 41/36

(52) U.S. Cl. 315/307

(57) ABSTRACT

A high frequency ballast for a fixed output high intensity discharge lamp is serially connected in order with a power input circuit, an electromagnetic wave interference filtering loop, a rectifying loop, a high power factor correction loop, a voltage-controlled oscillator ballast driver and a load loop, wherein the voltage-controlled oscillator ballast driver is connected with an ignition sequence control logic loop by a built-in voltage oscillator, and a half-bridge driving loop receives power transmitted by the high power factor correction loop and then converts into a steady power output by the ignition sequence control logic loop. When a lamp cannot start successfully, it can start by itself repeatedly through a restart triggering loop; and after the lamp has started, an operational amplifier circuit is used to maintain an original frequency which sets the power, so as to adjust automatically according to the lamps of various frequencies.

### BACKGROUND OF THE INVENTION

a) Field of the Invention

The present invention relates to a high frequency ballast, and more particularly to a high frequency ballast for a fixed output high intensity discharge lamp, which can output a constant power, and can adjust automatically according to frequencies.

b) Description of the Prior Art

A high intensity discharge (HID) lamp used in an existing market has been applied to illuminate in many ways for years. There are four major kinds of HID lamps in a practical application, such as mercury-vapor lamps, low-pressure sodium-vapor lamps, high-pressure sodium-vapor lamps and metallic halogen lamps. These HID lamps illuminate through discharge of high-pressure or low-pressure gas, and are now the most widely used electric light sources due to a high illumination efficiency. However, due to a discharge mechanism of the gas discharge electric light source, its normal working area is usually provided with a negative resistance feature, meaning that as an electric current increases, a voltage decreases on the contrary, and vice versa. Hence, if the gas discharge lamp is directly connected to a voltage source, the lamp will be burnt out as the electric current increases rapidly to exceed a limit, and a ballast should be connected serially in a circuit to restrict the electric current.

A ballast of a medium power (250 W˜400 W) high intensity discharge lamp and a ballast of a metallic halogen lamp sold in the existing market are mostly electromagnetic ballasts, their working voltages include 110VAC and 220VAC, and a working frequency of all ballasts is 60 Hz. Therefore, none of a light energy efficiency, a power factor, a power loss and a lifetime of usage of the high intensity discharge lamp can achieve an energy-saving effect.

Accordingly, how to solve the aforementioned problems and shortcomings in the prior art is a technological issue of research and development for improvement by the present inventor and related vendors.

### SUMMARY OF THE INVENTION

The primary object of the present invention is to provide a high frequency ballast for a fixed output high intensity discharge lamp, which is serially connected in order with a power input circuit, an electromagnetic wave interference filtering loop, a rectifying loop, a high power factor correction loop, a voltage-controlled oscillator (VCO) ballast driver and a load loop, wherein the VCO ballast driver is electrically connected to an ignition sequence control logic loop by a built-in voltage-controlled oscillator, and a half-bridge driving loop receives power transmitted by the high power factor correction loop and then converts into a steady power output by the ignition sequence control logic loop. When the lamp cannot start successfully, it can start by itself repeatedly through a restart triggering loop. After the lamp has started, an operational amplifier circuit is used to maintain an original frequency which sets the power, thereby performing an automatic adjustment according to the lamps of various frequencies.

Another object of the present invention is to provide a high frequency ballast for a fixed output high intensity discharge lamp, wherein by the VCO ballast driver, it can assure that all the driving and control functions that the HID lamp needs are provided, such as the ignition sequence control loop, a safety protection loop and an operational amplifier which are used to feedback an electric current loop of the HID lamp to achieve a performance of outputting a constant power.

Still another object of the present invention is to provide a high frequency ballast for a fixed output high intensity discharge lamp, wherein the high frequency (80 KHz˜100 KHz), constant power output (250 W˜400 W) ballast can be used in the high-pressure sodium-vapor lamp and the metallic halogen lamp, and can be used in the voltages of 110VAC and 220VAC, so as to reduce a volume of the ballast, decrease parts used in the circuits, and increase functions of the ballast.

Yet still another object of the present invention is to provide a high frequency ballast for a fixed output high intensity discharge lamp, wherein this kind of ballast can be used in any brands of high-pressure sodium-vapor lamps and metallic halogen lamps, and can be used in the voltages of 110VAC and 220VAC, thereby enabling the ballast to be used very conveniently, and the light energy efficiency, the high power factor and the low loss to achieve the energy-saving effect.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a circuit diagram of a high frequency ballast for a fixed output high intensity discharge lamp, according to the present invention.

FIG. 2 shows a block diagram of FIG. 1.

FIG. 3 shows a circuit diagram of a voltage-controlled oscillator ballast driver of the present invention.

FIG. 4 shows a block diagram of FIG. 3.

### DETAILED DESCRIPTION OF THE PREFERRED EMBODIMENTS

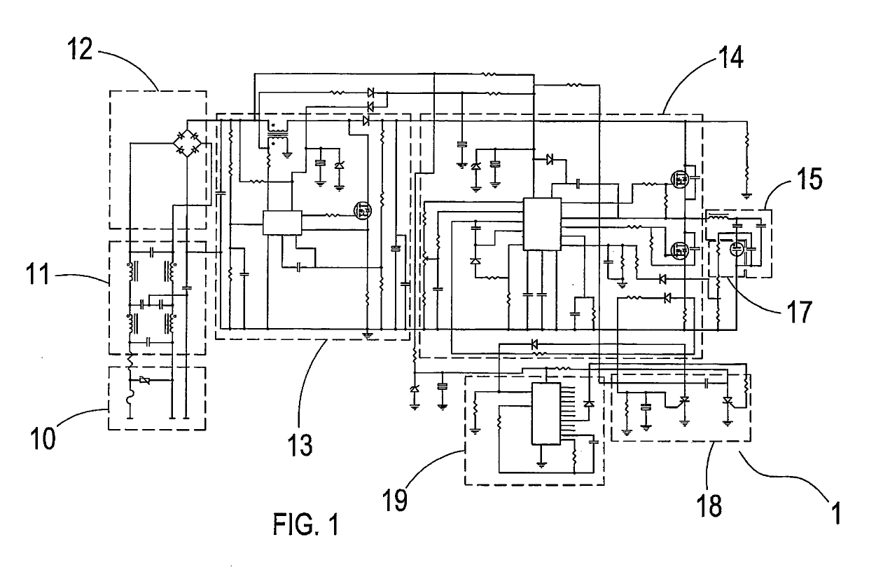

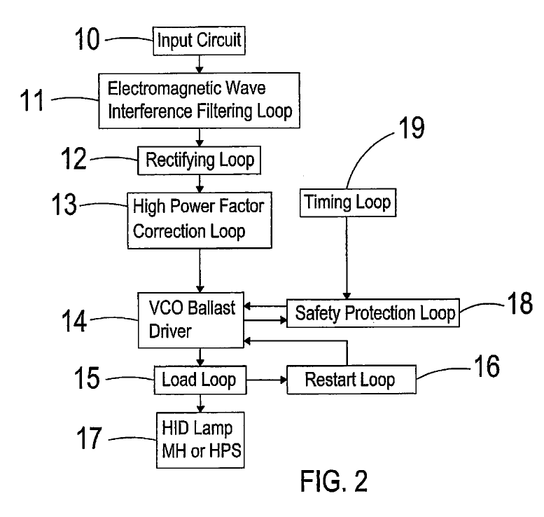

Referring to FIG. 1 and FIG. 2, it shows a circuit diagram of a high frequency ballast for a fixed output high intensity discharge lamp and a block diagram of FIG. 1, according to the present invention. A high frequency ballast 1 of a fixed output high intensity discharge lamp is serially connected in order with a power input circuit 10, an electromagnetic wave interference filtering loop 11, a rectifying loop 12, a high power factor correction loop 13, a voltage-controlled oscillator ballast driver 14 and a load loop 15, wherein the power input circuit 10 is connected with an external power source and filters common mode and differential mode noises out of the power by the electromagnetic wave interference filtering loop 11, whereas the rectifying loop 12 and the high power factor correction loop 13 rectify the power and correct the power factor, respectively. The voltage-controlled oscillator ballast driver 14 is connected with an input end of the load loop 15, and an output end of the load loop 15 is connected respectively with a restart loop 16 and a lamp-set 17. As the restart loop 16 is electrically connected with the voltage-controlled oscillator ballast driver 14, when the lamp does not start successfully, the voltage-controlled oscillator ballast driver 14 can start by itself repeatedly through the restart loop 16. On the other hand, the voltage-controlled oscillator ballast driver 14 is electrically connected with a safety protection loop 18 bi-directionally to protect the voltage-controlled oscillator ballast driver 14 and to control a start time by a timing loop 19.

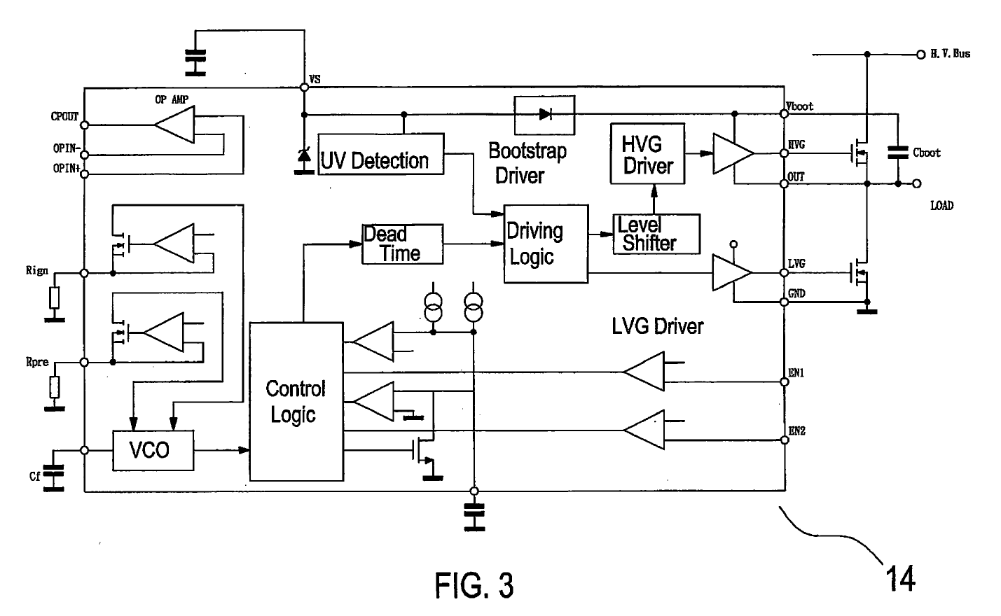

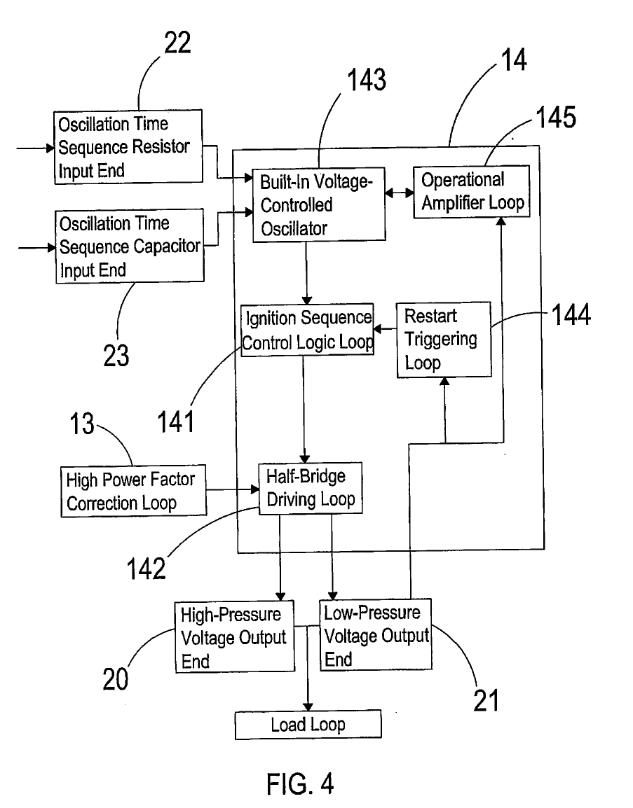

Referring to FIG. 3 and FIG. 4, it shows a circuit diagram of a voltage-controlled oscillator ballast driver and a block diagram of FIG. 3, according to the present invention. The voltage-controlled oscillator ballast driver 14 is electrically connected to an ignition sequence control logic loop 141 by a built-in voltage-controlled oscillator 143, and a half-bridge driving loop 142 receives power transmitted from the high power factor correction loop 13, and then converts to a steady power output by the ignition sequence control logic loop 141. When the lamp does not start successfully, it can start by itself repeatedly through a restart triggering loop 144, and after the lamp has started, an original frequency for setting up the power is maintained by an operational amplifier circuit 145.

The aforementioned voltage-controlled oscillator ballast driver 14 is a half-bridge oscillator driver chip and further includes a high-pressure voltage output end 20, a low-pressure voltage output end 21, an oscillation time sequence resistor input end 22 and an oscillation time sequence capacitor input end 23, wherein an output end of the operational amplifier loop 145 forms a parallel loop with the oscillation time sequence resistor input end 22 through resistors and diodes, an anti-phase input end is connected to a source of a MOSFT (Metal Oxide-Silicon Semiconductor Field Effect Transistor) of the low-pressure voltage output end 21, with the source being grounded through a resistor, whereas, a non anti-phase input end is connected to a modulatable reference voltage.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A high frequency ballast for a fixed output high intensity discharge lamp, which is serially connected in order with a power input circuit, an electromagnetic wave interference filtering loop, a rectifying loop, a high power factor correction loop, a voltage-controlled oscillator ballast driver and a load loop, wherein the power input circuit is connected with an external power source and filters common mode and differential mode noises out of the power by the electromagnetic wave interference filtering loop, whereas the rectifying loop and the high power factor correction loop rectify the power and correct the power factor, respectively, with the voltage-controlled oscillator ballast driver being connected with an input end of the load loop, an output end of the load loop being connected with a restart loop, and the restart loop being electrically connected with the voltage-controlled oscillator ballast driver; the voltage-controlled oscillator ballast driver being constituted by an ignition sequence control logic loop, a half-bridge driving loop, a built-in voltage-controlled oscillator, a restart triggering loop and an operational amplifier loop, with the ignition sequence control logic loop being electrically connected with the half-bridge driving loop, the half-bridge driving loop receiving power transmitted by the high power factor correction loop and then converting into a steady power output by the ignition sequence control logic loop; a lamp not able to start successfully starting by itself repeatedly through the restart triggering loop, and after the lamp has started, the operational amplifier loop being used to maintain an original frequency which sets the power, thereby performing an automatic adjustment according to the lamps of various frequencies.

2. The high frequency ballast for a fixed output high intensity discharge lamp, according to claim 1, which is further provided with a safety protection loop that is electrically connected with the voltage-controlled oscillator ballast driver to protect the driver.

3. The high frequency ballast for a fixed output high intensity discharge lamp, according to claim 1, which is further provided with a timing loop that is electrically connected with the voltage-controlled oscillator ballast driver to protect the driver.

4. The high frequency ballast for a fixed output high intensity discharge lamp, according to claim 1, wherein the restart loop is electrically connected with the voltage-controlled oscillator ballast driver.

5. The high frequency ballast for a fixed output high intensity discharge lamp, according to claim 1, wherein the voltage-controlled oscillator ballast driver is a half-bridge oscillator driver chip and further includes a high-pressure voltage output end, a low-pressure voltage output end, an oscillation time sequence resistor input end, an oscillation time sequence capacitor input end and an operational amplifier circuit, an output end of the operational amplifier circuit forming a parallel loop with the oscillation time sequence resistor input end through resistors and diodes, an anti-phase input end being connected to a source of a MOSFT (Metal Oxide-Silicon Semiconductor Field Effect Transistor) of the low-pressure voltage output end, with the source being grounded through a resistor, and a non anti-phase input end being connected to a modulatable reference voltage.
